(19) United States
(12) Patent Application Publication
(10) Pub. No.: US 2009/0001184 A1
(43) Pub. Date: Jan. 1, 2009

(54) Method For Starting an Additional Heater for a Motor Vehicle

(75) Inventor: Markus Renner, Riemerling (DE)

Correspondence Address: ROBERTS MLOTKOWSKI SAFRAN & COLE, P.C.;Intellectual Property Department, P.O. Box 10064, MCLEAN, VA, 22102-8064, US

(73) Assignee: WEBASTO AG, Stockdorf (DE)

(21) Appl. No.: 11/574,289

(22) PCT Filed: Aug. 5, 2005
(86) PCT No.: PCT/EP2005/008476

§ 371 Date: Feb. 26, 2007

(30) Foreign Application Priority Data
Aug. 25, 2004 (DE) 10 2004 041 201.4

(51) Int. Cl. B60H 1/22

(52) U.S. Cl. 237/12.3 C; 123/179.2

(57) ABSTRACT

A process for starting a supplementary direct injection vehicle heater (10) with the following steps: detecting a starting signal (14) which is independent of the ignition process of the internal combustion engine (12), initiating measures to prepare for heating operation of the supplementary direct injection vehicle heater (10) when the starting signal (14) has appeared, and initiation of heating operation of the supplementary direct injection vehicle heater (10) when the internal combustion engine (12) is being started.

The invention relates to a process for starting the supplementary direct injection heater of a vehicle and a control device for the supplementary direct injection heater of a vehicle.

To improve the climatic conditions in the interior of motor vehicles, supplementary direct injection vehicle heaters are often used. In this connection auxiliary heaters are known, i.e. heating systems which are used only to support normal heating operation of the vehicle heating system. Likewise independent vehicle heaters are known. They can generally be operated both in addition to the vehicle heating system and also with the vehicle stationary.

DE 196 01 772 C2 discloses a process for starting such a supplementary direct injection vehicle heater. In this connection it is described that for pure auxiliary heaters the starting process of the heater is initiated by actuating the ignition key. In heaters which allow preheating, i.e. independent vehicle heaters, according to DE 196 01 772 C2 the starting process can also be initiated by another function, since the heater in this case is able to work independently of operation of the internal combustion engine.

When using pure auxiliary heaters the effort is made to increase the heat output after starting the internal combustion engine as quickly as possible in order to improve the climate in the vehicle interior and the operating conditions for the internal combustion engine as quickly as possible.

The object of the invention is to enable more rapid heating of a vehicle interior via changing the manner of operation mode of the supplementary direct injection vehicle heater.

This object is achieved with the features of the independent claims.

Advantageous embodiments of the invention are given in the dependent claims.

The invention consists in a process for starting a supplementary direct injection vehicle heater with the following steps: detecting a starting signal which is independent of the internal combustion engine ignition process, initiating measures to prepare for heating operation of the supplementary direct injection vehicle heater when the starting signal has appeared, and initiation of heating operation of the supplementary direct injection vehicle heater when the internal combustion engine is being started. Within the framework of operation of preheaters, execution of the generic steps of detection of a starting signal which is independent of the ignition process of the internal combustion engine and of initiation of measures to prepare for heating operation in the presence of a starting signal is known. Within the framework of this invention it is provided that these steps also be undertaken to initiate auxiliary heating operation so that heating operation of the supplementary direct injection vehicle heater can be initiated based on preparatory measures when the internal combustion engine is started up. The auxiliary heater is therefore already activated when the internal combustion engine is not yet started, for example by supplying the glow plug with current and/or flushing the heater. With starting of the internal combustion engine on this basis then heat generation can be immediately begun so that more rapid heating in the vehicle interior can be achieved.

It is usefully provided that the starting signal is delivered by opening the central locking system. The opening of the vehicle via the central locking system is a reliable indicator that starting of the internal combustion engine is forthcoming. Since the central locking system is furthermore a component of the vehicle which is supplied with electricity, it is available as a source for the starting signal.

Furthermore, it is possible for the starting signal to be delivered by a keyless locking system. Within the framework of this disclosure, a keyless locking system is defined as a system which allows opening of the vehicle when an encoder approaches it closely enough. Since this approach to the vehicle is likewise a reliable indicator for possible later starting of the vehicle, this is likewise available as a source for a starting signal.

Furthermore it can be provided that initiation of measures to prepare for heating operation of the supplementary direct injection vehicle heater and initiation of heating operation of the supplementary direct injection vehicle heater can be stopped by an auxiliary operating function. It can happen that a vehicle is being opened without subsequent starting operation of the internal combustion engine. In particular when this often takes place subsequently, initiation of measures which prepare for heating operation of the supplementary direction injection heater is undesirable. Therefore the user of the vehicle is enabled to stop initiation of these preparatory measures via an auxiliary operating function, for example by longer actuation of remote control button for the central locking system or also by actuating an additional button.

For comparable reasons it can be provided that another necessary prerequisite for initiating measures to prepare for heating operation of the supplementary direct injection vehicle heater and initiating heating operation of the supplementary direct injection vehicle heater can be delivered by an auxiliary operating function. In this case therefore the initiating measures are only taken when this is explicitly caused by the driver, for example by longer actuation of the remote control button for the central locking system or also by actuating an additional button.

It can furthermore be useful for the ambient properties inside or outside the vehicle to afford the necessary prerequisites for initiating measures to prepare for heating operation of the supplementary direct injection vehicle heater and initiating heating operation of the supplementary direct injection vehicle heater. These ambient properties can be for example the outside temperature and cooling water temperature. At a high outside temperature or high cooling water temperature starting of the auxiliary heater and thus also initiation of preparatory measures via the system functions would be stopped.

It is usefully provided that the signals considered in the starting process are available via the vehicle bus. This is a useful measure which can be easily implemented within the framework of modern motor vehicle engineering.

The invention furthermore consists in a control device for a supplementary direct injection vehicle heater with means for detecting a starting signal which is independent of the internal combustion engine ignition process, means for initiating measures to prepare for heating operation of the supplementary direct injection vehicle heater when the starting signal has appeared, and means for initiating heating operation of the supplementary direct injection vehicle heater when the internal combustion engine is being started. In this way the advantages and particulars of the process as claimed in the invention are also implemented within the framework of the control device. This also applies to the especially preferred embodiments of the process as claimed in the invention.

The invention furthermore relates to a supplementary direct injection vehicle heater and a vehicle with a control device as claimed in the invention.

The invention is based on the finding that valuable time for starting of heating operation of a supplementary direct injection heater can be saved when the required preparatory measures are initiated early. Since various actions are undertaken on the vehicle before the internal combustion engine is started up, for example opening of the central locking system or also any other actions, the heater can be prepared completely for starting of the combustion process when the ignition of the internal combustion engine is actuated and thus auxiliary heating operation can begin.

The invention is explained by way of example with reference to the attached drawings using especially preferred embodiments.

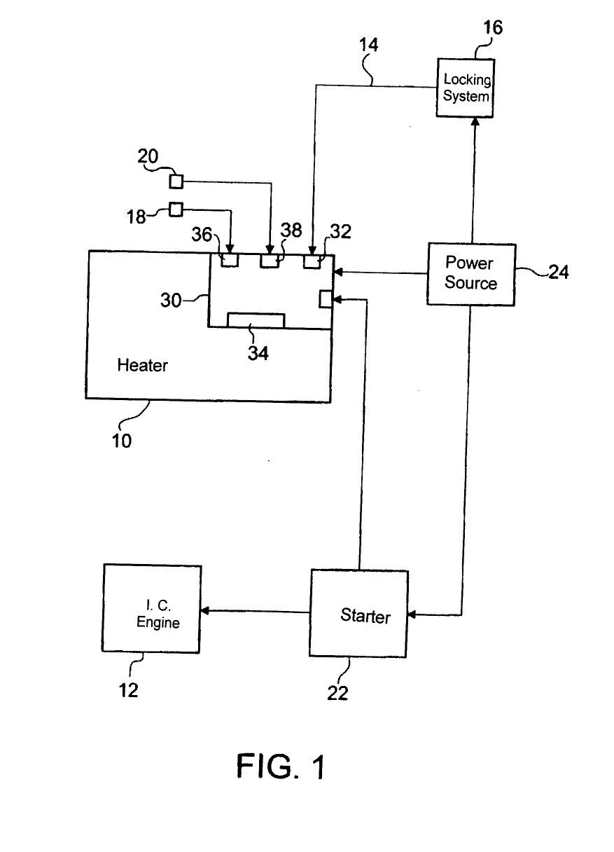

FIG. 1 shows a schematic block diagram of the heating system with a supplementary direct injection vehicle heater as claimed in the invention and

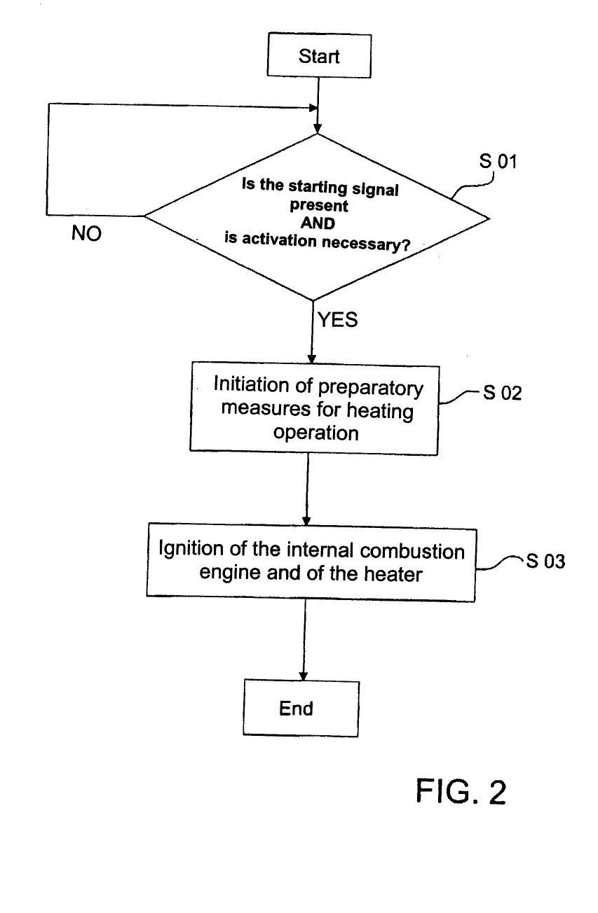

FIG. 2 shows a flow chart of the process as claimed in the invention.

FIG. 1 shows a schematic block diagram of the heating system with a supplementary direct injection vehicle heater as claimed in the invention. The supplementary direct injection vehicle heater 10 comprises in addition to the known components for operating such a heater a control device 30. This control device has several signal inputs, of which three inputs 32, 36, 38 are shown by way of example. Furthermore the control device 30 comprises functional units, one functional unit 34 being shown by way of example. In addition to the vehicle heater 10, other components are a central locking system 16, an internal combustion engine 12, a starter 22 and a power source 24, for example a vehicle battery. Furthermore an element 18 for preparing an auxiliary operating function and a temperature sensor 20 are shown.

The system shown in FIG. 1 operates as follows to start the supplementary direct injection vehicle heater 10. When the vehicle is at rest, the control device 30 of the supplementary direct injection vehicle heater 10, the central locking system 16 and the starter 22 are supplied with electricity by the vehicle battery, so that in particular the central locking system 16 can be actuated first. Based on this actuation of the central locking system 16, the vehicle doors open; in addition a starting signal 14 is output to the input 32 of the control device 30 of the vehicle heater 10. Based on this starting signal 14 measures which prepare for heating operation can now be initiated by means of the function element 34. Whether these measures are initiated can be made dependent for example on the signals detected at the inputs 36 and 38, so that starting of the supplementary direct injection heater can be stopped via the auxiliary operating function 18 or such that this auxiliary operating function 18 is necessary for starting of the heater. The temperature sensor 20 for example stands for a cooling water temperature sensor and/or outside temperature sensor.

FIG. 2 shows a flow chart of a process as claimed in the invention. After starting, it is detected in step S01 whether there is a signal which has been delivered by a central locking system and whether activation of the heater based on an existing heating energy demand is necessary. The question of the existing heating energy demand is answered in the negative when the outside temperature is high or when the cooling water is hot enough. This checking according to step S01 takes place cyclically until the presence of a signal and the necessity of activation can be answered in the affirmative. Consequently in step S02 the preparatory measures for heating operation of the vehicle heater are initiated. In step S03 then with start-up of the internal combustion engine the supplementary direct injection vehicle heater is ignited. With this the starting process of the heater is ended.

The features of the invention disclosed in the specification above, in the drawings and in the claims can be important to the invention both individually and also in any combination for implementation of the invention.

### REFERENCE NUMBER LIST

10 supplementary direct injection vehicle heater
12 internal combustion engine
14 starting signal
16 central locking system
18 auxiliary operating function
20 temperature sensor
22 starter
24 vehicle battery
30 control device
32 input
34 function element
36 input
38 input

1. Process for starting a supplementary direct injection vehicle heater (10) with the following steps:
detecting a starting signal (14) which is independent of the ignition process of the internal combustion engine (12),
initiating measures to prepare for heating operation of the supplementary direct injection vehicle heater (10) when the starting signal (14) has appeared, and
initiation of heating operation of the supplementary direct injection vehicle heater (10) when the internal combustion engine (12) is being started.

2. Process as claimed in claim 1, wherein the starting signal (14) is delivered by opening the central locking system (16).

3. Process as claimed in claim 1 wherein the starting signal is delivered by a keyless locking system.

4. Process as claimed in claim 1, wherein initiation of measures to prepare for heating operation of the supplementary direct injection vehicle heater (10) and initiation of heating operation of the supplementary direct injection vehicle heater (10) are stopped by an auxiliary operating function (18) when heating by the supplementary direct injection heater is unnecessary due to existing temperature conditions or when the vehicle is not to be operated.

5. Process as claimed in claim 1, wherein a necessary prerequisite for initiating measures to prepare for heating operation of the supplementary direct injection vehicle heater (10) and initiating heating operation of the supplementary direct injection vehicle heater (10) are delivered by an auxiliary operating function (18).

6. Process as claimed in claim 5, wherein the ambient properties (20) inside or outside the vehicle provide the necessary prerequisites delivered by the auxiliary operating function for initiating measures to prepare for heating operation of the supplementary direct injection vehicle heater (10) and initiating heating operation of the supplementary direct injection vehicle heater (10).

7. Process as claimed in claim 1, wherein the signals considered in the starting process are provided via a vehicle power bus.

8. Control device (30) for a supplementary direct injection vehicle heater (10) with
means (32) for detecting a starting signal (14) which is independent of the ignition process of the internal combustion engine (12),
means (34) for initiating measures to prepare for heating operation of the supplementary direct injection vehicle heater when the starting signal (14) has appeared, and
means for initiating heating operation of the supplementary direct injection vehicle heater (10) when an internal combustion engine (12) is being started.

9. Supplementary direct injection vehicle heater (10) with a control device, comprising
a heater, and
a control device connected to the heater, the control device having:
means (32) for detecting a starting signal (14) which is independent of the ignition process of the internal combustion engine (12)
means (34) for initiating measures to prepare for heating operation of the supplementary direct injection vehicle heater when the starting signal (14) has appeared, and
means for initiating heating operation of the supplementary direct injection vehicle heater (10) when an internal combustion engine (12) is being started.

10. Vehicle with a control device, comprising
a motor vehicle having an internal combustion engine,
a heater, and
a control device connected to the heater, the control device having:
means (32) for detecting a starting signal (14) which is independent of the ignition process of the internal combustion engine (12),
means (34) for initiating measures to prepare for heating operation of the supplementary direct injection vehicle heater when the starting signal (14) has appeared, and
means for initiating heating operation of the supplementary direct injection vehicle heater (10) when the internal combustion engine (12) is being started.
